(19) United States
(12) Patent Application Publication
(10) Pub. No.: US 2005/0062579 A1
(43) Pub. Date: Mar. 24, 2005

(54) Resettable fuse with visual indicator

(75) Inventor: Larry E. Wilson, Marion, ID (US)

Correspondence Address: WALL MARJAMA & BILINSKI, 101 SOUTH SALINA STREET, SUITE 400, SYRACUSE, NY, 13202, US

(73) Assignee: Carrier Corporation

(21) Appl. No.: 10/668,841

(22) Filed: Sep. 23, 2003

(51) Int. Cl. H01H 85/30

(52) U.S. Cl. 337/265

(57) ABSTRACT

A resettable switch has a light emitting diode in parallel connection therewith such that when the resettable switch is in a tripped condition, the resulting voltage drop across the LED causes a sufficient flow of current therein to illuminate the LED. A diode and resistor are placed in serial connection with said LED in order to protect the LED from excessive voltage and current.

### BACKGROUND OF THE INVENTION

This invention relates generally to electrical fuses and, more particularly, to fuses that are automatically resettable.

In order to protect electronic devices from overload conditions that result from fault or shorts in one more circuits, it is common to use a fuse to open the circuit when the current raises to an undesirable level. Standard fuses, which have filaments that melt when the current reaches a threshold level and therefore must be replaced. An alternative has been a circuit breaker wherein the excessive current causes the opening of a switch which must then be manually reset by an operator.

The expense and inconvenience of the above described protective devices has been overcome by the use of a resettable switch, which automatically resets itself and does not require the action of an operator. Such a resettable fuse is made of a material exhibiting a positive temperature coefficient of resistance (PTC). At normal current flows and temperatures, the conductive particles of a PTC form chains or paths in the polymer matrix to create a polymer composite with high electrical conductivity. When the material is exposed to excessive current flows, resistive heating generated by the excessive current flows through the conductive particle chains causes the polymer to self-heat above its glass transition temperature. This increase in temperature results in an increase in the electrical resistance of the material and substantially reduces the amount of current which flows through the PTC device into the protected circuit. Once the overload condition is cleared, the polymer self cools and contracts where the conductive particles again form conductive paths to resume low resistance electrical current conduction.

One problem with such a resettable fuse is that its condition cannot be visually detected by an observer without testing it. That is, unlike the older thermal fuses that melted to show that the fuse was “blown”, the resettable fuse does not change its appearance when it is in a tripped state. Accordingly, the person servicing the equipment being protected by the tripped fuse is not able to determine that the fuse has in fact tripped. Such a condition therefore complicates the troubleshooting process since it would not be readily apparent that a fault had occurred.

It is therefore an object of the present invention to provide an improved method and apparatus for detecting a tripped resettable fuse condition.

Another object of the present invention is the provision in a resettable fuse installation for the ability to visually observe a tripped condition in a resettable fuse.

Yet another object of the present invention is the provision for visually detecting a tripped condition in a resettable fuse.

Still another object of the present invention is the provision for a resettable fuse which is economical to manufacture and effective and efficient in use.

These objects and other features and advantages become more readily apparent upon reference to the following description when taken in conjunction with the appended drawings.

### SUMMARY OF THE INVENTION

Briefly, in accordance with one aspect of the invention, a visual indicator of a voltage drop such as an incandescent bulb or a light emitting diode (LED) is placed in parallel relationship with a resettable fuse, such that, when the resettable fuse is in the tripped position, the voltage drop across the parallel circuit will cause sufficient current to flow through the LED in order for it to be illuminated, thereby allowing a serviceman to detect the fault condition.

In accordance with another aspect of the invention, a diode is placed in series connection with the LED in order to prevent reverse voltage from damaging the LED during periods in which the resettable fuse is tripped and reverse voltage is applied such as the negative half cycle of an AC source.

By yet another aspect of the invention, a resistor is placed in series with the LED to prevent the current flow through the LED from exceeding a level which would damage or destroy the LED.

In the drawings as hereinafter described, a preferred embodiment is depicted; however various other modifications and alternate constructions can be made thereto without departing from the true sprit and scope of the invention.

### BRIEF DESCRIPTION OF THE DRAWINGS

FIG. 1 is a circuit diagram of the present invention as installed in a circuit for fault protection thereof.

### DESCRIPTION OF THE PREFERRED EMBODIMENT

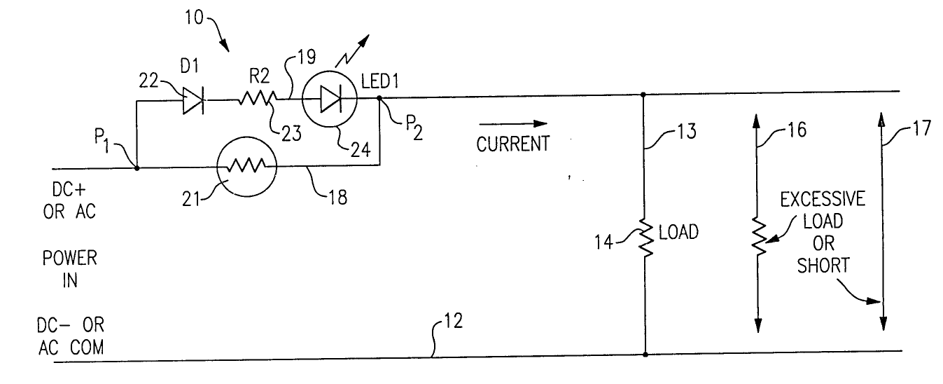

Referring now to FIG. 1, the invention is shown generally at 10 as disposed between a pair of points P1 and P2 of an electrical circuit as shown. A power source 11, which is either an AC source or a DC source, is applied to point P1.

Electrically connected to points between point P2 and ground 12 as a line 13 containing a load 14. An example of such a circuit is that in a recreation vehicle wherein the load is a 12 volt gas valve for a water heater or a furnace. During normal operation the current flows through line 13 and provides power to the load 14 as required.

During a fault condition, such as will occur when the load becomes excessive as indicated by the line 16 or a short occurs across the circuit as represented by the line 17, the current flow may be come excessive and could cause damage to the electrical components within the load 14 or in other portions of the circuit. The protective circuit is connected between the two points P1 and P2 as provided to limit such excessive current flow.

The protective circuit of the present invention includes a pair of lines 18 and 19 connected in parallel between points P1 and P2. Disposed in line 18 is a resettable fuse 21 which, under normal operating conditions will allow the current to flow between points P1 and P2. It is a positive temperature coefficient resistor that under normal operating conditions will have a very low resistance and will exhibit a very low voltage drop. When an excessive load or a shorted circuit condition occurs, the resettable fuse 21 will heat rapidly and its resistance will increase substantially. In that condition, the fault current will be reduced to a very low level, with the voltage drop across P1-P2 remaining relatively high.

In the other line 19 of the circuit, there is disposed in serial relationship a diode 22, a resistor 23 and a LED 24. During normal operation, when the current is flowing freely through the resettable fuse 21, very little, if any current is flowing through the circuit line 19. However, when the resettable fuse 21 is tripped to cause a relatively high voltage condition across P1-P2, current is caused to flow through the line 19. It will cause the illumination of the LED 24 to thereby provide a visual indication of the trip or fault condition. The diode 22 and the resistor 23 protect the LED from excessive voltage and current. When the fault condition is corrected, the resettable fuse rapidly cools and resets to its low resistance state, thereby extinguishing the LED 1.

Rather than the diode, resistor and LED, other visual indicators can be used. For example, an incandescent lamp or a voltmeter could be placed in the line 19 in order to shown the increased voltage condition across the two points P1 and P2.

### EXAMPLE

A typical circuit is one having a power source of 12 volts that powers a load 14 that includes a gas valve for a water heater or furnace. A suitable resettable fuse 21 is a 30R185 which is commercially available from Littlefuse, Inc. The LED 24 is a HLMP-K111 which is commercially available from Fairchild, Inc. and is designed to illuminate with the current of 2-20 ma. The diode 22 can be of various types, and preferably is a ⊥N4007 diode having the following characteristic:

| | |
|---|---|
| Peak Reverse Voltage | 1000 V |
| Ave. Forward Current | 1 A |

A suitable resistor 23 is of 2200 ohms.

Although the present invention has been described with reference to a particular embodiment thereof, it will be understood by those skilled in the art that modifications and variations can be effected within the spirit and scope of the invention.

1. An electrical fault indicator connected between two circuit points disposed between a voltage source and a load, comprising:
a parallel circuit electrically interconnected between said two circuit points and having in one conduction path a resettable fuse and having in a second parallel conduction path a visual indicator of a voltage drop, wherein, when said resettable switch is in a tripped position, the resulting increased voltage between the two circuit points will result in the flow of sufficient current through said visual indicator as to be detected by an observer.

2. A fault indicator as set forth in claim 1 wherein said visual indicator is an LED that is illuminated by the current flow.

3. A fault indicator as set forth in claim 2 wherein said second parallel conducting path includes a diode in series with said LED.

4. A fault indicator as set forth in claim 2 wherein said second parallel conduction path includes a resistor in series with LED.

5. A fault indicator as set forth in claim 3 wherein said second parallel conducting path also includes a resistor in series with said diode and said LED.

6. A method of providing a visual indication of a tripped fuse in an electrical circuit, comprising the steps of:
providing a resettable fuse in series between a voltage source and a load;
and providing a visual indicator of voltage in parallel connection with said resettable fuse;
such that when said resettable fuse trips as a result of a fault in the electrical circuit, the resulting high voltage will cause current flow through said visual indicator and allow it to be visually observed.

7. A method as set forth in claim 6 wherein said visual indicator of voltage is an LED.

8. A method as set forth in claim 7 and including the further step of providing a diode in series with said LED.

9. A method as set forth in claim 7 and including the further step of providing a resistor in series with said LED.

10. A method as set forth in claim 8 and including the further step of providing a resistor in series with said LED and said diode.

11. A resettable fuse circuit comprising:
a resettable fuse to be electrically interconnected between a power source and a load; and
a visual indicator of voltage being interconnected between the power source and the load, in parallel with said resettable fuse, said resettable fuse and said visual indicator of voltage being so selected and having the characteristic that when said resettable fuse is in a tripped condition, the voltage drop across said visual indicator of voltage is increased sufficiently for its condition to be visually observable.

12. A resettable fuse circuit as set forth in claim 11 wherein said visual indicator of voltage is an LED which is illuminated by the voltage drop.

13. A resettable fuse circuit as set forth in claim 12 and including a diode in series with said LED.

14. A resettable fuse circuit as set forth in claim 12 and including a resistor in series with said LED.

15. A resettable fuse circuit as set forth in claim 13 and including a resistor in series with said LED and said diode.
